(19) United States
(12) Patent Application Publication
(10) Pub. No.: US 2026/0071742 A1
(43) Pub. Date: Mar. 12, 2026

(54) Lighting device, coupling apparatus and lighting system

(71) Applicant: Gerolamo Angelo BONFANTI, Robbiate (IT)

(72) Inventor: Gerolamo Angelo BONFANTI, Robbiate (IT)

(21) Appl. No.: 19/108,090

(22) PCT Filed: Aug. 31, 2023
(86) PCT No.: PCT/IB2023/058608

§ 371 Date: Feb. 28, 2025

(30) Foreign Application Priority Data
Sep. 1, 2022 (IT) 102022000017940

(51) Int. Cl. F21V 21/35; F21V 15/01; F21V 21/005; F21V 21/02; F21V 23/00; F21V 23/06; F21Y 115/10

(52) U.S. Cl. CPC F21V 21/35; F21V 15/01; F21V 21/005; F21V 21/025; F21V 23/002; F21V 23/06; F21Y 2115/10

(57) ABSTRACT

A lighting system comprises a plurality of lighting devices, each of which comprises in turn an electrified track (10) consisting of a main body (12) which is longitudinally elongated and comprises two side walls (18) and an upper wall (16). The lighting device also comprises a lighting body (40) composed of a light source (42), a printed circuit (44) and an electrical connector (46) connected to the printed circuit (44). The electrified track (10) comprises a plurality of grooves (30, 32) extending along the entire longitudinal extension of the main body (12) and arranged on the upper wall (16) of the main body (12), and at least one electrical conductor (34, 34′, 36, 36′) arranged inside each groove (30, 32). The electrical connector (46) of the lighting body (40) is electrically connected directly to the electric conductor (34, 34′, 36, 36′) arranged inside the electrified track (10).

The present invention relates to the sector of lighting systems in building structures and has been developed with particular reference to a lighting device, a coupling apparatus and a lighting system.

In the lighting sector, and in particular in the indoor lighting sector, lighting apparatus and systems comprising one or more so-called “electrified tracks” are known. An electrified track is a longitudinally elongated supporting and power supply structure able to distribute electric power along its entire length. The track is generally fixed to or suspended from a ceiling or fixed to a wall of a room.

The aforementioned lighting apparatus and systems therefore comprise a lighting body mechanically and electrically connected to a connection element which, in turn, is mechanically and electrically connected to the electrified track.

These systems are particularly advantageous and of interest since the lighting body may be positioned at any point along the track and may be displaced or removed. Furthermore, these systems are attractive from an aesthetic point of view owing to their limited dimensions and small volume.

One of the more delicate aspects of these systems concerns the methods for engaging the connection element with the electrified rail and the lighting body with the connection element, necessary for positioning, displacing and/or removing the lighting body from the lighting device or system.

Another equally delicate aspect is the joining together of several electrified tracks necessary for providing a complex lighting system.

Various solutions are known, these comprising connection elements which are manually operated or connection elements which allow automatic connection when the connection element is inserted in the electrified track.

These solutions, however, are such that the housing of the connection element and/or of the lighting body are very visible, this being a condition which is not favourably viewed by design architects. Furthermore, these solutions do not ensure a uniform light emission precisely because of their form. In fact, the devices and systems of the known type as described above comprise track portions without light sources since they are occupied by the connection element or by coupling apparatus.

Last but not least, the lighting systems of the known type usually comprise a plurality of components each designed for a different function: lighting, current transmission and control logic. Owing to this variety of components the construction of complex lighting systems is more difficult and subject to constraints. The general object of the present invention is to provide a lighting device which is able to ensure lighting which is uniformly distributed along its length and which results in simpler, as well as more orderly and more efficient, installation of a lighting system.

In view of this object, the Proprietor has had the idea of providing, according to the invention, a lighting device as defined in claim 1.

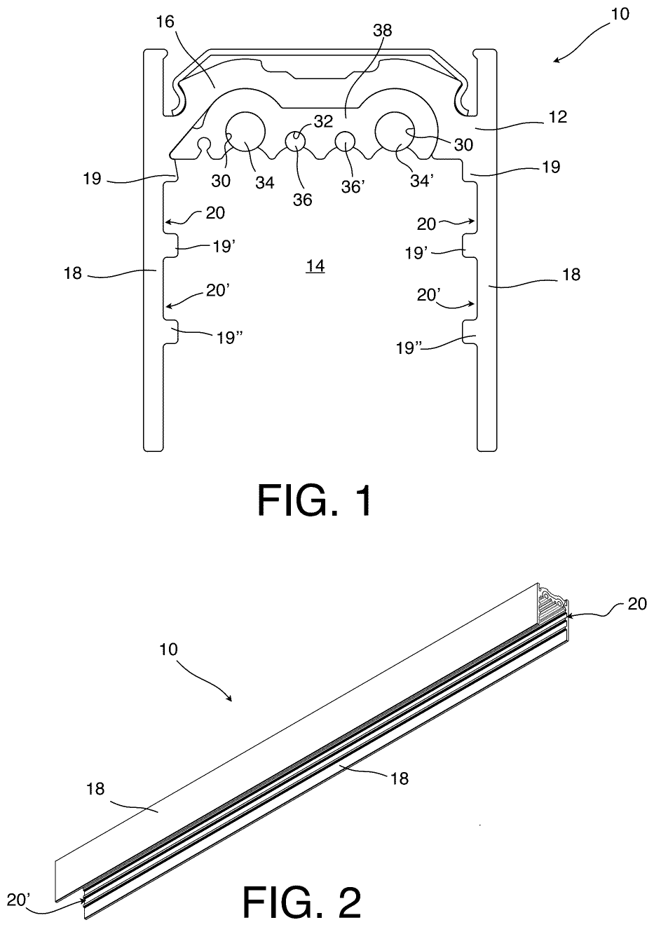

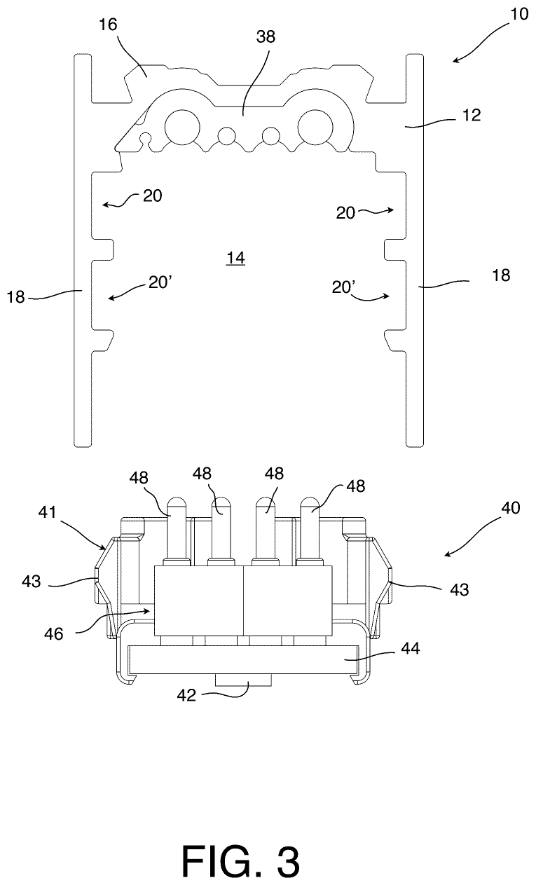

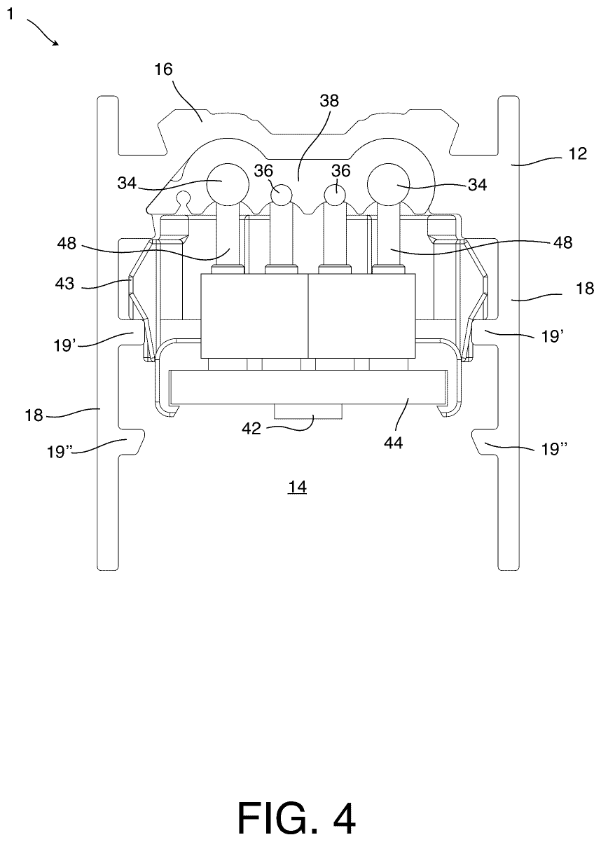

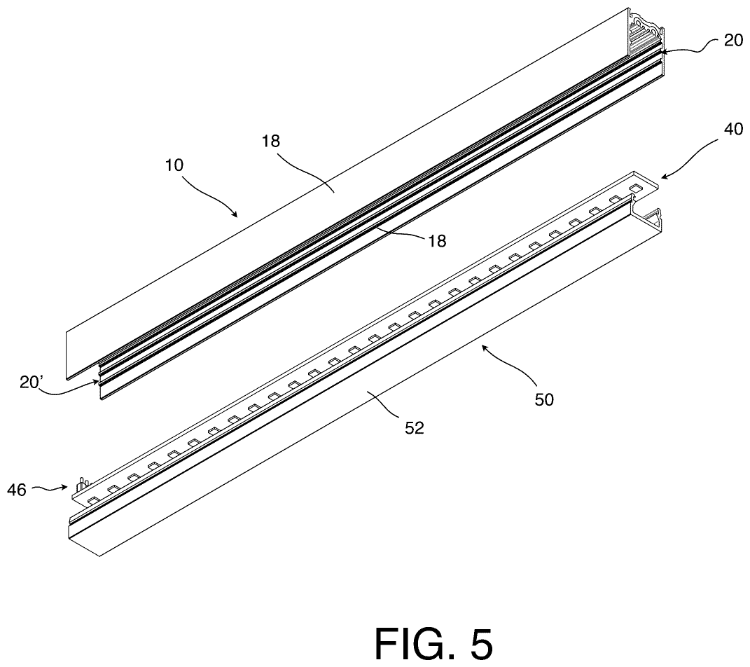

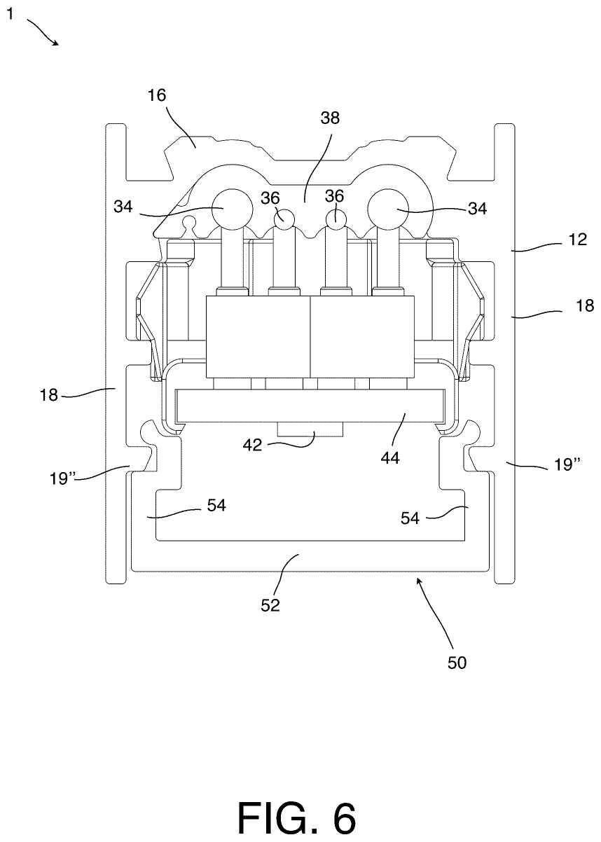

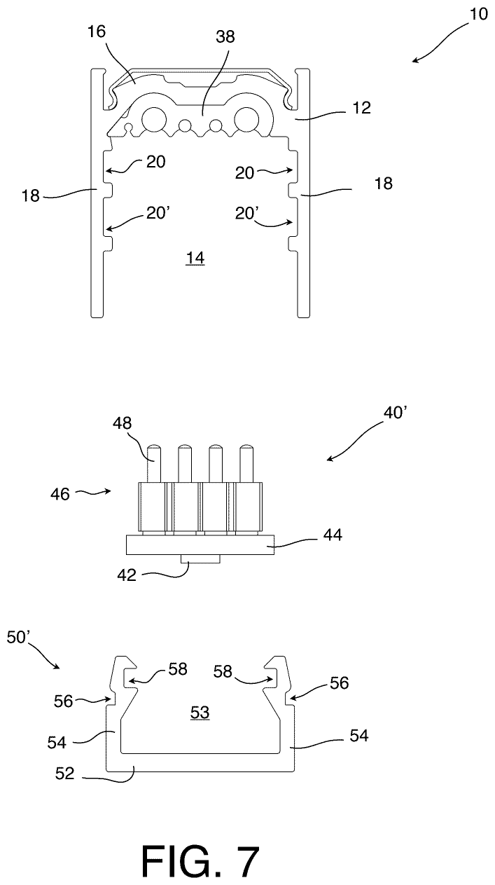

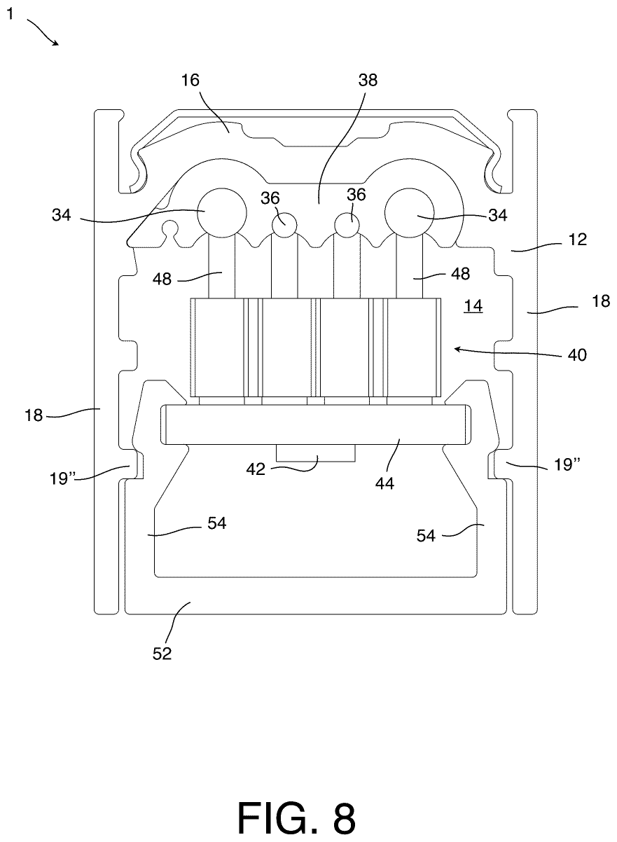

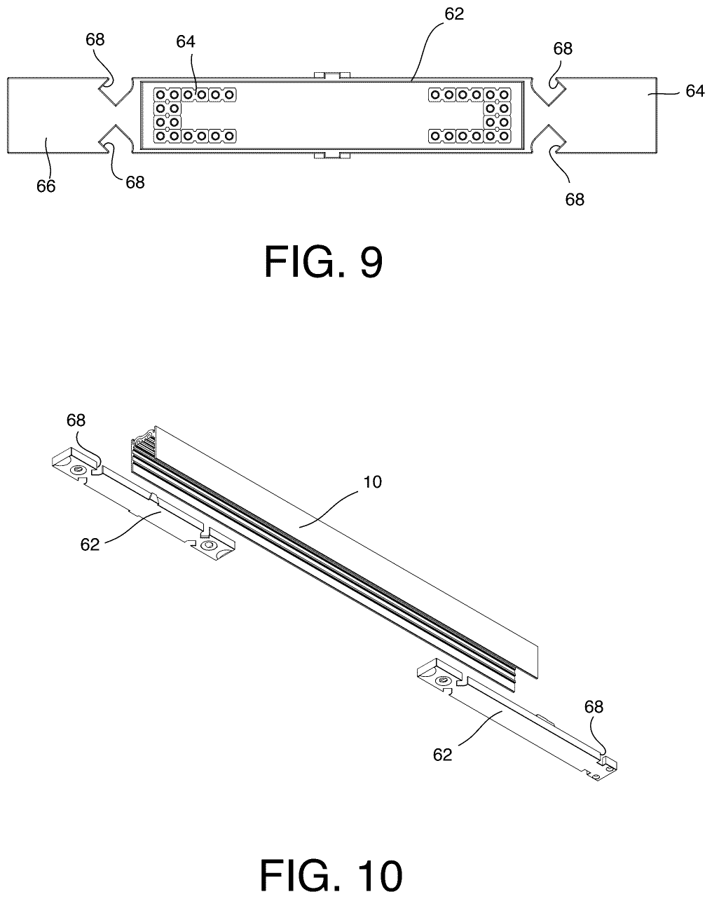

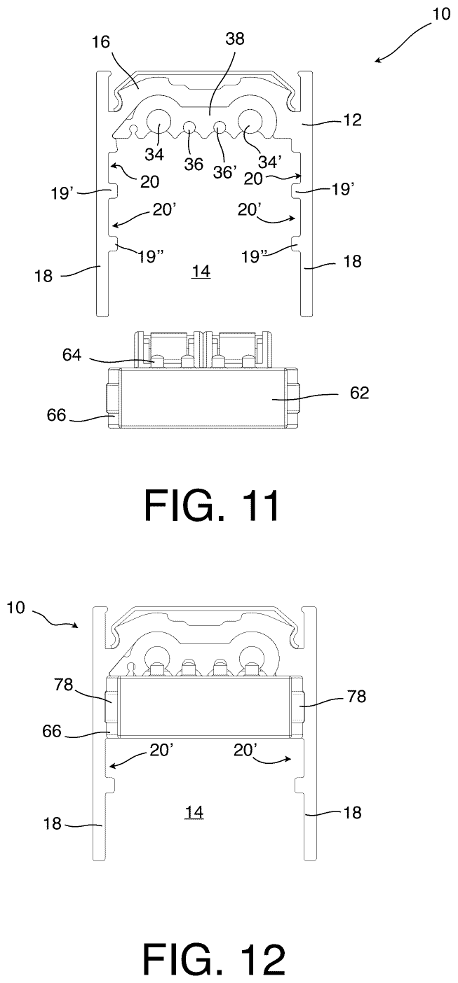

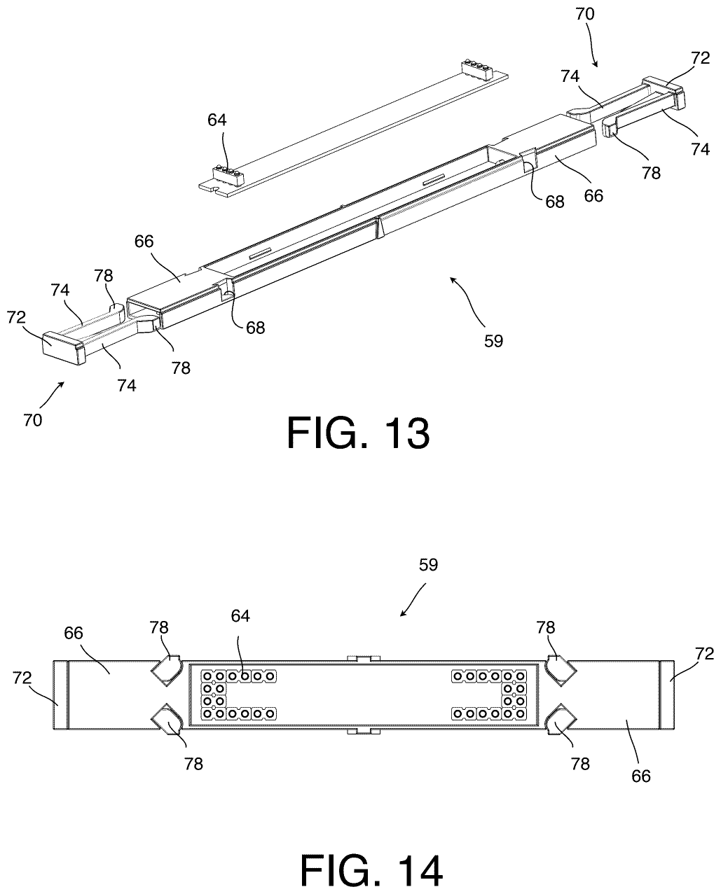

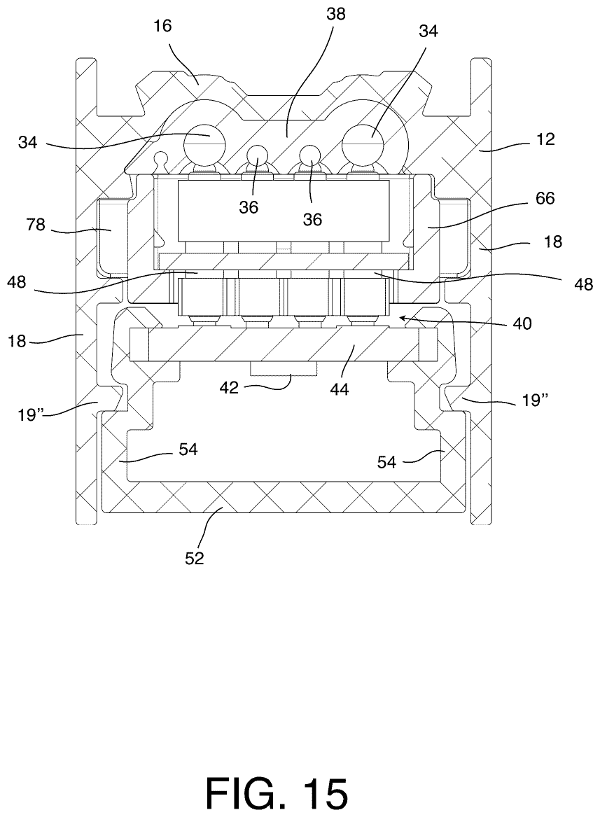

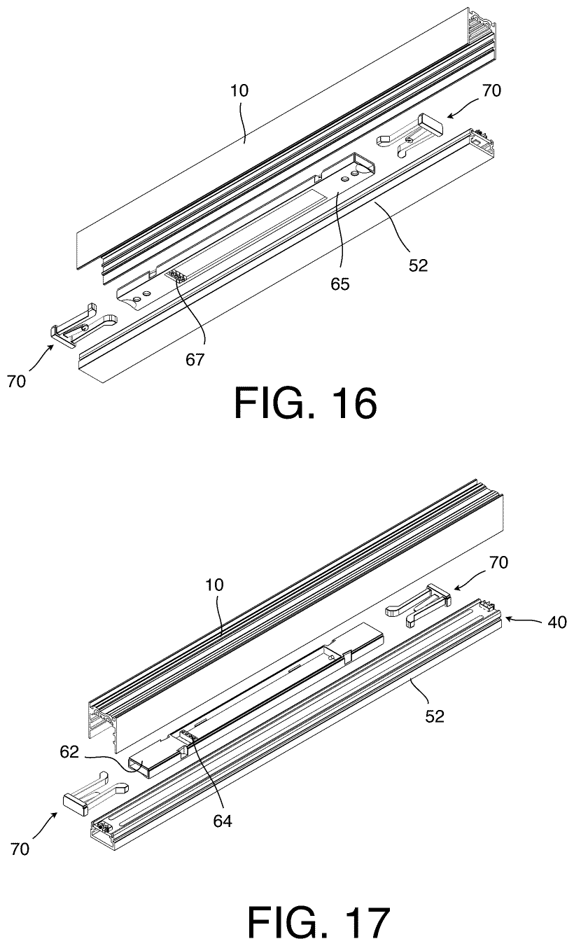

Further characteristic features and advantages of the present invention will become clear from the following description, provided by way of example with reference to the attached drawings in which:
FIG. 1 shows a schematic side view of an electrified track according to the present invention;
FIG. 2 shows an axonometric view of the electrified track according to FIG. 1;
FIG. 3 shows an exploded schematic view of a first embodiment of a lighting device according to the present invention;
FIG. 4 shows a schematic side view of the lighting device according to FIG. 3 in an operating position thereof;
FIG. 5 shows an exploded axonometric view of the lighting device according to FIG. 3;
FIG. 6 shows a schematic side view of a second embodiment of the present invention;
FIG. 7 shows an exploded schematic view of a third embodiment of the present invention;
FIG. 8 shows a schematic side view of the lighting device according to FIG. 7 in an operating position thereof;
FIG. 9 shows a top plan view of a connection body according to the present invention;
FIG. 10 shows an exploded schematic view of a first step for assembly of a coupling apparatus according to the present invention;
FIG. 11 shows a schematic side view of the assembly step according to FIG. 10;
FIG. 12 shows a schematic side view of a step following the step shown in FIG. 11;
FIG. 13 shows a schematic axonometric view of a connection body and an engaging mechanism according to the present invention;
FIG. 14 shows a schematic top plan view of a coupling apparatus according to the present invention;
FIG. 15 shows a schematic cross-sectioned view of one of the embodiments of a lighting system according to the present invention;
FIG. 16 shows an exploded schematic view, from below, of the system according to FIG. 12; and
FIG. 17 shows an exploded schematic view, from above, of the system according to FIG. 12.

It is understood that elements or characteristics of one embodiment may be conveniently incorporated in other embodiments without further clarifications. Reference will now be made in detail to the various embodiments of the invention, one or more examples of which are shown in the attached figures. Each example is provided merely by way of illustration of the invention and is understood as not being a limitation thereof. For example, the technical characteristics shown or described since they form part of one embodiment may be integrated within, or associated with, other embodiments in order to produce a further embodiment. It is understood that the present invention will be inclusive of these modifications and variants.

In a first embodiment of the present invention, a lighting device 1 comprises an electrified track 10 which extends longitudinally along a first predetermined axis. The electrified track 10 comprises a main body 12 defining a longitudinal housing 14 elongated along said first predetermined axis.

According to one of the possible embodiments, the main body is an extruded aluminium body of predetermined length.

The main body 12 comprises an upper wall 16 and a pair of side walls 18 extending from the upper wall 16 in a direction substantially perpendicular to the plane passing through said upper wall 16.

The inner surface of each side wall 18, namely the surface facing the longitudinal housing 14, comprises a plurality of fastenings. In the embodiment shown in the attached figures, the fastenings of each side wall 18 comprises at least three projections 19, 19′, 19″ arranged in succession, and spaced from each other, on the inner surface of the side wall 18 and along its longitudinal extension, so as to define two grooves 20, 20′ extending along the entire length of the main body 12. As will become clearer below, the fastenings 19, 19′, 19″, 20, 21 are able, during use, to engage mechanically with the electrified track 10 a lighting body 40 in order to form a lighting device, and/or a coupling apparatus in order to form a lighting system. Obviously, it is possible to realize fastenings which are technically equivalent to those shown and consist of a different number, for example, but not exclusively, three or more, without thereby departing from the scope of the present invention. The electrified track 10 may also comprise a plurality of grooves extending along the entire longitudinal extension of the main body 12, arranged facing the longitudinal housing 14 and formed on the inner surface of the side wall 16.

According to the embodiment shown in FIG. 1, the electrified track 10 comprises two first grooves 30, each arranged close to a respective side wall 18, and two second grooves 32 arranged between the first two grooves 30. Preferably, but not exclusively, two of the grooves have a diameter greater than the diameter of the other two grooves. In the embodiment shown, the first two grooves 30 have a greater diameter than the second two grooves 32.

According to a particularly advantageous characteristic feature of the present invention, the electrified track 10 also comprises an electrical conductor 34, 34′, 36, 36′ arranged inside each groove 30, 32. The volume of each electrified conductor 34, 34′, 36, 36′ is such that each conductor 34, 34′, 36, 36′ is arranged, for example by means of interlocking engagement, inside a respective groove 30, 32. The conductors 34, 34′, 36, 36′ may be made with a cylindrical or sheet-like form of metallic material, for example copper, or other conductive material.

Still according to the embodiment shown, the larger-size conductor 34, 34′ is designed, during use, to provide an electric power supply, while the smaller-size conductor 36, 36′ is designed, during use, to transmit electric control signals, for example so as to perform the function of a data bus.

The electrified track 19 also comprises an insert made of electrical insulating material for insulating the conductors from the main body 12. In one of the preferred embodiments shown in FIG. 1, the insert of insulating material 38 is engaged with the upper wall 16 and with the side walls 18 of the main body 12. According to this configuration, the grooves 30, 32 are formed on the insert of insulating material 38. As can be clearly seen from the figures, this configuration positions all the electrical conductors 34, 34′, 36, 36′ on the upper wall 16 of the electrified track 10, leaving the side walls 18 free from any electrical contacts.

With particular reference to FIGS. 3 and 4, the lighting device 1 according to the present invention also comprises a lighting body 40 which is mechanically and electrically engaged directly with the electrified track 10.

The lighting body 40 also comprises a light source, for example, but not exclusively, an LED, and a circuit board, or a printed circuit 44. According to the embodiment shown, the light source comprises one or more LEDs 42 mounted on the side of the circuit board 44.

The lighting body 40 also comprises an electrical connector, preferably a connector comprising an electrical contact mounted on a resilient element which allows the electrical contact to modify its position if a predetermined pressure is exerted on it and to return into the initial condition once the aforementioned pressure is interrupted.

According to one of the preferred embodiments of the present invention, the electrical connector is a pogo pin 46 or a spring pin connected to the circuit board 44. The pogo pin 46 comprises a number of upper terminals 48 equal to the number of grooves 30, 32 and therefore to the number of conductors 34, 34′, 36, 36′ present on the electrified track 10.

Each electrical connector 46 may also comprise a connector comprising an electrical contact mounted on a resilient element which allows the electrical contact to modify its position if a predetermined pressure is exerted on it and to return into the initial condition once the aforementioned pressure is interrupted.

The dimensions of the lighting body 40 are determined by the number of LEDs 42 or by the extension of the LED on the printed circuit 44. The volume of the lighting body 40 is such that it may be housed inside the track 10.

The lighting body 40 also comprises an engaging element designed, during use, to fix the lighting body 40 directly onto the electrified track 10.

According to the embodiment shown in FIG. 3, the engaging element 41 is engaged with the LED board and comprises a pair of elastic lateral locating elements 43 projecting laterally from the body of the LED board.

During use, when inserting the lighting body 40 inside the longitudinal housing 14 of the electrified track 10, the two lateral locating elements 43 are compressed towards the centre of the LED board by the inclined surface of the projections 19″, 19′ of the electrified track 10. Once the lateral locating elements 43 have passed over the projections 19′, they return, owing to their elasticity, so as to project from the body of the LED board and are inserted inside the grooves 20 of the electrified track 10 so as to engage the lighting body 40 inside the electrified track 10.

Obviously, it is possible to provide also an engaging element comprising lateral projections which are not resilient and a manual mechanism which allows the lateral projections to be retracted inside and come out of the body of the lighting body 40. According to a further preferred embodiment of the present invention, the lighting device 10 also comprises a diffuser screen 50. As shown in FIG. 5, the diffuser screen 50 extends longitudinally along the first predetermined axis and comprises a bottom wall 52 and two side walls 54.

The diffuser screen 50 comprises a pair of fastenings which allow the diffuser screen 50 to be engaged with the electrified track 10.

In the embodiment shown in FIG. 6, each side wall 54 comprises an outer fastening 56 arranged on the outer surface of the side wall 54. For example, the outer fastenings 56 may comprise grooves extending longitudinally along the entire extension of the diffuser screen 50.

According to a further embodiment of the present invention shown in FIGS. 7 and 8, a lighting device 1 according to the present invention comprises the electrified track 10, as described above, and a lighting body 40′, as described above but without the engaging element 41, and a diffuser screen 50′.

According to this embodiment, the diffuser screen 50′ extends longitudinally along the first predetermined axis of the electrified track 10 , as shown in FIG. 5, and comprises a bottom wall 52 and two side walls 54, defining between them a housing 53 suitable for housing the lighting body 40′.

The diffuser screen 50′ comprises a plurality of fastenings which allow engagement of the illuminating body 40 with the diffuser screen 50′ and engagement of the diffuser screen 50′ with the electrified track 10.

In the embodiment shown in FIGS. 7 and 8, each side wall 54 comprises an outer fastening 56 arranged on the outer surface of the side wall 54 and an inner fastening 58 arranged on the inner surface of the side wall 54. For example, the inner fastenings 58 and outer fastenings 56 may comprise grooves extending longitudinally along the entire extension of the diffuser screen 50.

As shown more clearly in FIG. 8, the inner grooves 58 allow the side portions of the module 44 to be engaged with the diffuser screen 50′ and the outer grooves 56 allow the diffuser screen 50′ to be engaged with the projections 19″ of the electrified track 10.

In all the embodiments of the present invention described hitherto, the lighting body 40, in general an LED board, is provided on the upper side with a current supply system, namely the electrical connectors 46 for powering the LED board, and on the bottom side with the light source, for example an LED 42. This solution allows the direct electrical connection of the lighting body 40 to the electrified track 10, without the need for further intermediate electrical connection elements arranged between the lighting body 40 and the electrified track 10.

Once the lighting body 40 has been inserted in the electrified track 10, this configuration, as shown in the figures, is able to conceal the connections between the electrical conductors 34, 34′, 36, 36′ of the electrified track 10 and the LED board.

One of the advantages of this solution is precisely the totally concealment of the electrical connections, while ensuring a uniform emission of the light from the LED board by means of the diffuser screen installed in the electrified track 10.

With particular reference to FIGS. 9 to 14, a coupling apparatus 60 according to the present invention comprises a connection body 62 designed to be mechanically and electrically connected to two or more electrified tracks 10. The description of the electrified track 10 provided above is incorporated here for reference purposes. The connection body 62 has a box-like shape elongated in a predetermined longitudinal direction.

The coupling apparatus 60 comprises a pair of electrical connectors 64 arranged in the top portion and at the two ends of the connection body 62, as shown in FIGS. 13 and 14. Each electrical connector 64 is designed, during use, to come into contact with the conductors of a respective electrified track 10. In the embodiment shown in FIG. 16, each electrical connector comprises a plurality of pogo pins 64, or spring pins, which are designed to come into contact with the conductors 34, 34′, 36, 36′ of a respective electrified track 10 when the connection body 62 is inserted inside the electrified track 10, as shown in FIGS. 12 and 15.

As can be seen more clearly in FIGS. 15 to 17, the coupling apparatus 60 comprises a second electrical connector 67 which is arranged in the bottom portion of the connection body 62, connected to the first connector 64 and designed to connect a lighting body 40, as will become clearer below.

As shown in FIGS. 15 to 17, the second connector 67 comprises on its bottom surface a plurality of electrical connectors 69, for example, but not exclusively pogo pins 69, or spring pins, which are designed in particular to come into contact with the electrical connectors 46 of the lighting body 40.

As indicated above, each electrical connector 64, 67 may also be a connector comprising an electrical contact mounted on a resilient element which allows the electrical contact to modify its position if a predetermined pressure is exerted on it and to return into the initial condition once the aforementioned pressure is interrupted.

The end portions 66 of the connection body 62 are hollow and are designed to each house a mechanism for engaging the connection body 62 with a respective electrified track 10. The end portions 66 also comprise a pair of openings 68 formed in the side walls of the connection body 62.

The coupling apparatus 60 comprises a manual engaging mechanism 70. comprising a head 72 from which two longitudinal appendages 74, substantially parallel to each other, extend. Each of the ends 76 of the longitudinal appendages 74 comprises a foot 78.

The coupling apparatus 60 is used to connect mechanically and electrically two electrified tracks 10.

During assembly, a connection body 62 is inserted inside the longitudinal housing 14 of an electrified track 10 until the pogo pins 64 come into contact with the conductors 34, 34′, 36, 36′. Owing to the compression of the spring present inside the pogo pins, the terminals of the pogo pins 64 are retracted inside the body and allow the engaging mechanism 70 to be housed both inside the grooves 20′ of the electrified track and inside the grooves 20.

Owing to this particularly advantageous characteristic feature, as will become clearer below, both a connection body 62 and a lighting body 40 and/or a diffuser screen 50 may be housed inside the same electrified track 10. The former inside the grooves 20 and the latter inside the grooves 20′.

Then an engaging mechanism 70 is inserted manually inside the connection body 62. In the embodiment shown, the appendages 74 slide inside the connection body 62 until the feet 78 are inserted into the openings 68 and protrude out from the connection body 62. In this way, the feet 78 allow the coupling apparatus to be secured to the electrified track 10 by means of mechanical interaction with the grooves 20. The same operation is repeated with the other engaging mechanism 70 for connecting a second electrified track 10.

Obviously it is possible to envisage different mechanical mechanisms, which are manually operated and allow the coupling apparatus 60 to be secured to the electrified tracks, i.e. mechanisms which are different from, but technically equivalent to those described and illustrated hitherto.

A lighting system according to the present invention comprises at least two electrified tracks 10, at least one lighting body 40, and at least one coupling apparatus 60, wherein the at least one lighting body 40 and the at least one coupling apparatus 60 are designed to be inserted inside the electrified track 10. The descriptions of the electrified track 10, the lighting device 40 and the coupling apparatus 60 given above are incorporated herein for reference purposes.

In the embodiment shown, the circuit board 44 of the lighting body 40 comprises, on the upper surface, one or more elongated electrical contacts or traces 45 which extend over the entire longitudinal extension of the circuit board 44. The traces 45 are designed to come into contact with the electrical contacts 69 of the second electrical connector 67 when the connection body 60 and the lighting body 40 are inserted inside the electrified track 10, as shown in FIG. 15.

Owing to this configuration it is possible to install in the same longitudinal portion of an electrified track 10 both a lighting body 40 and a coupling apparatus 60 and to modify the configuration of the lighting system without having to modify the arrangement of the electrified tracks or disassemble part of the system.

In fact, as shown in the cross-sectional view of FIG. 15, in a portion of an electrified track 10, the electrical conductors 34, 34′, 36, 36′, a coupling apparatus 60 and a lighting body 40, are all inserted inside the electrified track 10 and are arranged vertically above one another.

Furthermore, owing to the presence of the second electrical connectors 67 and the traces 45, it is possible to ensure along the entire longitudinal extension of a plurality of electrified tracks 10 the presence of a lighting body 40 and therefore provide a continuous lighting system.

It is pointed out that, owing to the component system employed for the current supply, which uses a spring pin, three functional arrangements may be obtained:
a first arrangement where the current is supplied directly from the track conductor to the LED board;
a second arrangement, positioned underneath the light source/LED board, so that it is not visible, which allows the supply and transmission of the current between one track and another;
a third arrangement, again positioned underneath the light source/LED board, which allows the insertion of advanced analog or digital control systems (of the DALI or 0-10 type).

1. A lighting system comprises:
at least two electrified tracks (10) each comprising:
a main body (12) longitudinally elongated and comprising two side walls (18) and an upper wall (16);
a plurality of grooves (30, 32) extending along the entire longitudinal extension of the main body (12) and arranged on the inner surface of the upper wall (16) of the main body (12); and
at least one electrical conductor (34, 34′, 36, 36′) arranged inside each groove (30, 32);
at least one lighting body (40) designed to be inserted inside the electrical track (10) and comprising:
a light source (42),
a circuit board (44), and
an electrical connector (46) connected to the circuit board and to the light source (44);
a coupling apparatus (60) designed to connect together mechanically and electrically the at least two electrified tracks (10) and comprising:
a connection body (62);
a pair of electrical connectors (64) arranged in the upper portion and at the two ends of the connection body (62), the electrical connectors (64) being electrically connected directly to the at least one electrical conductor (34, 34′, 36, 36′) arranged inside the electrified track (10); and
a second electrical connector (67) arranged in the bottom portion of the connection body (62) and connected to the first connector (64) and to the lighting body (40);
characterized in that
the at least one electrified conductor (34, 34′, 36, 36′), the coupling apparatus (60) and the at least one lighting body (40) are arranged vertically above one another inside the electrified track (10).

2. A lighting system according to claim 1, characterized in that the circuit board (44) of the lighting body (40) comprises, on the upper surface, one or more elongated electrical contacts (45) which extend along the entire longitudinal extension of the circuit board (44) and are designed to come into contact with the second electrical connector (67), when the connection body (60) and the lighting body (40) are inserted inside the electrified track (10).

3. A lighting system according to claim 1, characterized in that an inner surface of each side wall (18) of the electrified track (10) comprises at least one fastening (19, 19′, 19″, 20, 20′).

4. A lighting system according to claim 3, characterized in that the fastenings comprise at least three projections (19, 19′, 19″) arranged in succession, and spaced from each other, on the inner surface of a side wall (18) of the electrified track (10) and along its longitudinal extension, so as to define two grooves (20, 20′) extending along the entire length of the main body (12).

5. A lighting system according to claim 4, characterized in that the coupling apparatus (60) and the lighting body are engaged, by means of mechanical interaction, with the fastenings (20, 20′) of the electrified track (10).

6. A lighting system according to claim 1, characterized in that the lighting body (40) comprises a diffuser screen (50) comprising a bottom wall (52) and two side walls (54).

7. A lighting system (1) according to claim 6, characterized in that the diffuser screen (50) comprises a pair of fastenings (56) for engaging the diffuser screen (50) with the electrified track (10).

8. A lighting system (1) according to claim 7, characterized in that the side walls (54) of the diffuser screen (50) define between them a housing (53), suitable for housing the lighting body (40), and comprise a plurality of fastenings (56, 58) which allow engagement of the lighting body (40) with the diffuser screen (50) and engagement of the diffuser screen (50) with the electrified track (10).

9. A lighting system according to claim 1, characterized in that the coupling apparatus (60) comprises a manual engaging mechanism (70) suitable for engaging the connection body (60) with an electrified track (10), said manual engaging mechanism (70) comprising a head (72) from which there extend two longitudinal appendages (74) comprising at their ends (76) a foot (78) adapted to engage with openings (68) formed in the connection body (60).

10. A lighting system according to claim 1, characterized in that the electrical connectors (46, 47) are spring pins.
